(19) United States
(12) Patent Application Publication
(10) Pub. No.: US 2024/0269588 A1
(43) Pub. Date: Aug. 15, 2024

(54) LIQUID SEPARATION DEVICE FOR A COMPRESSOR SYSTEM, COARSE SEPARATOR FOR SUCH A LIQUID SEPARATION DEVICE, AND LIQUID SEPARATION SYSTEM

(71) Applicant: KNORR-BREMSE SYSTEME FÜR SCHIENENFAHRZEUGE GMBH, Munich (DE)

(72) Inventors: Adrian KRAMLICH, Munich (DE); Thomas KIPP, Munich (DE); Marc-Oliver HERDEN, Munich (DE); Wolfgang KUHN, Munich (DE); Michael WINKLER, Munich (DE); Cornelia SPRINGL, Bernau am Chiemsee (DE); Johannes GRAW, Munich (DE)

(21) Appl. No.: 18/692,141

(22) PCT Filed: Aug. 29, 2022
(86) PCT No.: PCT/EP2022/073945

§ 371 Date: Mar. 14, 2024

(30) Foreign Application Priority Data
Sep. 15, 2021 (DE) 10 2021 210 219.0

(51) Int. Cl. B01D 45/08; B01D 50/20

(52) U.S. Cl. CPC B01D 45/08; B01D 50/20

(57) ABSTRACT

The present invention relates to a liquid separation device for a compressor system, comprising a coarse separator, which has at least one separation surface and at least one mixture supply designed to supply an air-liquid mixture to the separation surface, wherein the mixture supply a mixture feed outlet which faces the separation surface and is arranged relative to the separation surface of the coarse separator such that a mixture flow impinging on the separator surface is guided substantially tangentially over at least one portion of the separation surface.

### CROSS REFERENCE AND PRIORITY CLAIM

This patent application is a U.S. National Phase of International Patent Application No. PCT/EP2022/073945 filed Aug. 29, 2022, which claims priority to German Patent Application No. 10 2021 210 219.0, the disclosure of which being incorporated herein by reference in their entireties.

### FIELD

Disclosed embodiments relate to a liquid separation device for a compressor system, to a coarse separator for such a liquid separation device, and to a liquid separation system having such a liquid separation device and/or such a coarse separator.

### BACKGROUND

In compressor systems such as compressor systems having an oil-lubricated screw compressor, the air that is compressed by the compressor can contain oil that is used for lubrication and cooling purposes. In order to retain the oil in the compressor system for further use, or at least in order to reduce an excessive release of oil to the external surroundings of the compressor system, use is made of liquid separation systems, or in this case oil separation systems. Such liquid separation systems have, for example, a coarse separator and a fine separator. Simple, maintenance-free structures are used as coarse separators. The compressed air-oil mixture from a compressor is directed onto such structures, also known as baffle plates, at a relatively large angle via a pressure nozzle. Depending on the impingement speed and the impingement angle, oil droplets of varying size form as a result of the impingement of the air-oil mixture. Relatively large oil droplets fall directly from the baffle plate, or in a region close to the baffle plate, into an oil sump under the action of gravitational force. However, the relatively small droplets that form as a result of the impingement are transported onward, as secondary spray, in the direction of the fine separator by the mixture flow. The higher the remaining fraction of oil in the air-oil mixture that reaches the fine separator, the shorter the service life of the fine separator or of a coalescence filter, for example, which is used for this purpose. Furthermore, the greater the oil quantity that has to be suctioned out in the fine separator, the less efficient the compressor system becomes.

### SUMMARY

In view of the statements above, disclosed embodiments provide a liquid separation device for a compressor system, a coarse separator for such a liquid separation device, and a liquid separation system having such a liquid separation device and/or such a coarse separator, by which the liquid separation efficiency for the compressor system can be increased.

### BRIEF DESCRIPTION OF THE FIGURES

The disclosed embodiments are discussed in more detail below on the basis of exemplary embodiments and with reference to the appended figures. In the figures:

FIG. 1 is a schematic cross-sectional illustration of a liquid separation system according to an example from the prior art;

FIG. 2 is a schematic cross-sectional illustration of a liquid separation system according to an exemplary refinement, having a liquid separation device according to a first exemplary embodiment;

FIG. 3a is a schematic cross-sectional illustration of a liquid separation device in a plane parallel to and through a longitudinal axis of a coarse separator according to a second exemplary embodiment;

FIG. 3b is a schematic cross-sectional illustration of the liquid separation device in a plane perpendicular to the longitudinal axis, according to the second exemplary embodiment;

FIG. 4a is a schematic cross-sectional illustration of a liquid separation device in a plane parallel to and through a longitudinal axis of a coarse separator according to a third exemplary embodiment;

FIG. 4b is a schematic cross-sectional illustration of the liquid separation device in a plane perpendicular to the longitudinal axis, according to the third exemplary embodiment;

FIG. 5a is a schematic cross-sectional illustration of a liquid separation system according to an exemplary variant, having a liquid separation device according to a fourth exemplary embodiment; and

FIG. 5b is a schematic cross-sectional illustration of the liquid separation system in a plane parallel to a liquid sump according to the fourth exemplary embodiment.

### DETAILED DESCRIPTION

In view of the statements above, disclosed embodiments provide a liquid separation device for a compressor system, a coarse separator for such a liquid separation device, and a liquid separation system having such a liquid separation device and/or such a coarse separator, by which the liquid separation efficiency for the compressor system can be increased.

The object is achieved by a liquid separation device, a coarse separator and a liquid separation system according to the independent claims. Advantageous refinements of the invention can be found in the dependent claims.

According to the invention, a liquid separation device for a compressor system has a coarse separator, which has at least one separation surface, and at least one mixture feed, which is configured to feed an air-liquid mixture to the separation surface. The mixture feed is formed with a mixture feed outlet which faces toward the separation surface and which is arranged relative to the separation surface of the coarse separator such that a mixture flow that impinges on the separation surface is guided substantially tangentially over at least a portion of the separation surface, and furthermore optionally the separation surface is impinged on by flow tangentially, that is to say the mixture flow impinges tangentially on the separation surface.

The mixture feed may for example be a pressure nozzle via which the air-liquid mixture can be discharged from a compressor and fed via a pressure nozzle outlet as a mixture feed outlet to the coarse separator. The mixture feed or the mixture feed outlet is directed onto the separation surface that is provided on the coarse separator for the purposes of separating the liquid from the air-liquid mixture, in such a way that the separation surface is impinged on by flow substantially tangentially or at least at an angle that allows the mixture flow to be substantially, that is to say at least predominantly, conducted onward tangentially on the separation surface. Accordingly, the mixture flow does not predominantly rebound from the separation surface but is predominantly guided so as to be in contact with the separation surface. In other words, by way of a corresponding arrangement of the mixture feed or of the mixture feed outlet in relation to the separation surface, the angle at which the air-liquid mixture impinges on the separation surface is reduced in relation to a separation surface that is used in the sense of a baffle plate. The angle of impingement between the inflowing air-liquid mixture and the separation surface from the direction of the inflowing air-liquid mixture is in particular, optionally, 0° to 50°, 0° to 40°, 0° to 30°. The mixture flow that is subsequently guided substantially tangentially along the separation surface is then decelerated substantially by way of friction effects and an expansion of the flow cross section, such that the liquid is at least partially separated off from the mixture flow. The greater the intensity with which the mixture flow is decelerated, the more liquid droplets are separated off by gravitational force, and the larger these droplets are. The friction effects and expansion of the flow cross section can be influenced by a distance over which the mixture flow is guided along the separation surface. For example, a relatively long distance also results in more intense deceleration under otherwise similar conditions. The tangential guidance of the mixture flow along the separation surface furthermore reduces the secondary spray component. In particular, the secondary spray component is reduced by virtue of the mixture flow being guided tangentially such that dynamic pressures, such as can arise for example as a result of flow resistances and swirling or turbulence, can be kept low or substantially avoided.

As a result of the increase of the number of liquid or oil droplets that are already separated off at the separation surface into a liquid sump such as an oil sump, and as a result of the reduction of the secondary spray, the efficiency of the compressor system and the service life of a downstream further liquid separator, such as a fine separator, can be increased. Since the liquid separation at the separation surface of the coarse separator now occurs no longer only primarily owing to the impingement angle and the impingement speed, as in the case of a baffle plate, but also owing to the guidance along the separation surface with associated friction and deceleration effects, there is a greater range of design possibilities for the coarse separator.

Oil or oil-containing liquids can be used as liquid for cooling and/or lubricating a compressor system. Use may however alternatively also be made of other liquids or liquid mixtures that allow cooling and/or lubrication within the scope of defined specifications. Below, the term “oil” and terminology based thereon will also be used synonymously with the term “liquid”. Accordingly, the term “oil” also encompasses oil substitutes or other cooling and/or lubricating liquids for use in compressor systems.

In one refinement, the cross section of the mixture feed outlet facing toward the separation surface is smaller than or equal to, in particular smaller than or equal to half of to one third of, an exit area over which the mixture flow exits the coarse separator.

If the mixture feed outlet is smaller than the exit area for the mixture flow, this assists the expansion of the flow cross section of the mixture flow. More intense deceleration effects and thus greater separation rates can correspondingly be achieved. Particularly advantageous here is a ratio of 1:3 or less between the cross-sectional area of the mixture feed outlet and the exit area over which the mixture flow exits the coarse separator. The exit area over which the mixture flow exits the coarse separator corresponds here to an opening area of the coarse separator that is provided for the mixture flow to exit the coarse separator. In other words, the flow cross section of the mixture flow as it enters the coarse separator is in particular smaller than the fluidically relevant exit area for the mixture flow as the mixture flow as it exits the coarse separator.

In one refinement, the mixture feed is positionally fixedly connected or connectable to the coarse separator.

Accordingly, the mixture feed outlet can be arranged in a fixed position relative to the separation surface, such that the flow behavior of the mixture flow along the separation surface is, from a geometrical aspect, subject only to the tolerances of the connection of the mixture feed to the coarse separator. In relation to separate installation of the mixture feed and of the coarse separator, for example on respective housing sections of a compressor system, the positionally fixed connection of the mixture feed and of the coarse separator thus exhibits less fluctuation in terms of the relative position, and thus greater reproducibility in terms of separation performance. In particular, however, a restoration of the mixture feed with the coarse separator and/or a replacement of such a combination is hereby facilitated, because laborious adjustment operations can be omitted or can at least be performed outside a relevant housing portion.

In one refinement, the connection of the mixture feed to the coarse separator has connecting mechanisms, in particular at least one connecting strut, optionally three, wherein the connecting strut or the connecting struts are furthermore optionally deformable.

The mixture feed can be held in a fixed position relative to the coarse separator by the connecting mechanisms. For example, a connecting strut may be used as connecting mechanisms in order to arrange the mixture feed outlet positionally fixedly, with a predetermined spacing and angle, in relation to the separation surface. The connecting strut is thus connected or connectable both to the mixture feed and to the coarse separator. The use of multiple connecting struts, for example three connecting struts, optionally at intervals of approximately 120° about the mixture feed or the mixture feed outlet, can furthermore increase the stability of the positionally fixed connection. In order to compensate for tolerances or in order to adjust the impingement angle, the at least one connecting strut may also be deformable. The deformation is then for example plastic in nature, though may also be elastic in nature if the elastic deformation is arrestable.

As an alternative to the use of connecting struts, the mixture feed may also be positionally fixedly connected via connecting mechanisms to the coarse separator in some other way. For example, the mixture feed may be screwed into a mixture feed holder that is formed by the coarse separator.

In particular, the relative position of the mixture feed and the coarse separator is adjustable by an adjustment device.

For example, as an alternative or in addition to being deformable, the at least one connecting strut may also be telescopically variable in length. The connecting strut then itself has the corresponding adjustment device. The mixture feed and/or the coarse separator may however also have a fastening device for the at least one connecting strut, such that the connecting strut is fastenable in different length portions to the mixture feed and/or to the coarse separator. With regard to the aforementioned example of the mixture feed being screwed into a mixture feed holder that is formed by the coarse separator, the adjustment device may for example also be adjustably screwed in by way of the interaction of the threads of the mixture feed and of the mixture feed holder.

By the adjustment device, tolerance-induced deviations from a predetermined relative position of the mixture feed with respect to the coarse separator can be corrected, and it is even possible for an entirely different relative position to be set, for example for an intentionally changed flow behavior of the mixture flow.

The adjustment device may be configured such that it can be controlled by a control device in order for a relative position to be adjusted in controlled fashion. A change in position may for example be coupled to a monitoring device that detects a deviation from a predetermined relative position. A deviation may be detectable directly by position determination and/or indirectly by way of a flow measurement. Alternatively or in addition, the control device may also set the relative position in accordance with an operating mode of the compressor, a speed of impingement of the air-liquid mixture on the separation surface, and/or a state of the fine separator. For example, if the air-liquid mixture impinges on the separation surface at a relatively low impingement speed, a relatively large impingement angle can be set. The risk of secondary spray is lower in the case of relatively low impingement speeds, such that the separation surface can thus also be used to a certain degree as a baffle plate.

In one refinement, the connection of the mixture feed to the coarse separator is releasable.

The mixture feed or the coarse separator can accordingly be exchanged independently of one another and thereafter positionally fixedly connected to one another again.

Alternatively, the mixture feed and the coarse separator are formed integrally.

For example, the mixture feed and the coarse separator may be monolithically or non-releasably connected to one another. By virtue of the integral design being implemented in rigid form, the positionally fixed connection between the mixture feed and the coarse separator is relatively resistant to variation in the normal usage environment. As an alternative to a rigid form, the integral design may however also have at least partially deformable elements that enable the relative position to be adjustable. For example, the at least one connecting strut may have a gooseneck or flexible arm portion as an at least partially deformable element, by which a reversible change in the relative position is possible. Through the material selection and/or dimensioning of the at least one connecting strut or of a region thereof, the connecting strut can alternatively or additionally be at least partially deformed. With the deformation that is performed, the relative position between the mixture feed and the coarse separator, and thus the angle of impingement of the mixture flow on the separation surface, can be adjusted.

In one refinement, the separation surface, facing toward the mixture feed, of the coarse separator is substantially concavely curved at least in a cross-sectional portion through which the mixture flow is intended to pass, and the mixture feed is arranged such that the mixture flow is at least partially guided substantially along the concave curvature.

The radius of the concave curvature may be constant or variable. The mixture feed faces toward the concave curvature, such that the mixture flow can be guided over the concave curvature and thus runs, as it were, in arcuate fashion. This assists the tangential guidance of the mixture flow along the separation surface, but also further decelerates the mixture flow. The cross-sectional portion through which the mixture flow is to pass thus replicates the flow path of the mixture flow.

In particular, the separation surface of the coarse separator is parabolic or dome-shaped, in particular in the form of a dome which conically narrows toward the dome tip, and the mixture feed is arranged such that the mixture flow is guided at least from one side of the separation surface to the other side of the separation surface via a parabolic direction reversal or a dome arch.

If the coarse separator is formed for example as a cone with a rounded dome tip as a dome arch, the cone being open on the side situated opposite the dome tip, the mixture feed may be arranged in this opening region of the cone. The dome arch may however also be formed not by the dome tip but by some other concavely curved portion of the coarse separator. The separation surface is formed by the inside of the cone. The mixture feed outlet is then example oriented such that the air-liquid mixture is caused to flow to the dome arch tangentially along a cone side that points in the direction of the axis of symmetry of the cone, and subsequently from the dome arch toward the cone opening again along an opposite cone side. The cross-sectional portion through which the mixture flow is to pass may accordingly be a cross-sectional portion of the cone cross section through the dome arch and parallel to the axis of symmetry of the cone. In general, the cross-sectional portion through which the mixture flow is to pass is a cross-sectional portion of the dome arch which has a curvature of the dome arch. The conical form of the separation surface may also differ from a rotationally symmetrical cone. The above description is however also transferable to such a refinement, wherein the axis of symmetry would in this case be replaced by a longitudinal axis that extends from the opening side of the conical body to the dome arch or to the dome tip. The separation surface of the coarse separator may similarly also have some other concave curvature shape. In the case of a parabolic form of the separation surface, the mixture flow is guided at least over a curvature of the parabolic separation surface, which has a reversal point for the flow direction of the mixture flow. This portion corresponds to a parabolic direction reversal.

Alternatively, the separation surface of the coarse separator forms a parabolic, cylindrical or conical body with at least an open first end side, in particular with a closed second end side of the cylinder or a closed end portion, situated opposite the open first end side, of the parabolic or conical body, and the mixture feed is arranged such that the mixture flow is guided in a circumferential direction of the parabolic, cylindrical or conical body tangentially along the parabolic, cylindrical or conical separation surface in the direction of the open first end side.

In the case of a parabolic or conical body, the open first end side is in particular the end side that is widened in relation to a narrowed portion. The parabolic, cylindrical or conical body as a concavely curved body has a longitudinal axis that is surrounded by the concave curvature formed by the body in each case. In the case of a rotationally symmetrical cylinder or cone, the longitudinal axis is accordingly the axis of symmetry. The mixture feed or the mixture feed outlet is arranged such that the air-liquid mixture impinges on the separation surface in the direction of the open first end side, and is then guided tangentially in a circumferential direction along the separation surface in the direction of the open first end side.

For example, in the case of a cylindrical body, the mixture flow may be guided in spiral fashion along the cylinder inner surface, as a separation surface, in the direction of the open first end side. The tangential path on which the mixture flow is guided, and/or the number of circuits that the mixture flow performs around the longitudinal axis of the concavely curved body, can be adjusted depending on the angle of inclination of the mixture feed outlet and thus the impingement angle of the air-liquid mixture in the direction of the open first end side. By the angle of inclination, the risk of overlapping of the mixture flow in the direction of the longitudinal axis can also be reduced in order to avoid turbulence. Here, the cross-sectional portion through which the mixture flow is to pass in each case is a cross-sectional portion in a plane that intersects the longitudinal axis of the concavely curved body at the particular angle of inclination of the mixture flow. In the case of multiple circuits about the longitudinal axis, multiple cross-sectional portions through which flow is to pass follow one another in the direction of the longitudinal axis.

If the second end side of the cylinder or the closed end portion, situated opposite the open first end side, of the parabolic or conical body is closed, it can be ensured that the air-liquid mixture or a proportion of the mixture flow does not escape through the second end side of the cylinder or through the closed end portion, situated opposite the open first end side, of the parabolic or conical body. The mixture flow is thus led out of the open first end side in controlled fashion.

In particular, the separation surface is curved such that the mixture flow can, proceeding from its flow direction when exiting the mixture feed to the point at which it exits the coarse separator, be diverted through at least 90°, in particular 120°, optionally 150° and optionally 170°.

The concave curvature or one of the refinements described above in this regard thus has a separation surface which, in a flow direction of the mixture flow, is curved through at least 90°, in particular 120°, optionally 150°, and optionally 170°, at least over the distance covered by the mixture flow. As a result of the diversion of the mixture flow that can thus be achieved, a pressure loss can be generated, which in turn decelerates the mixture flow. The deceleration effect in turn allows an increase of the separation rate.

In one refinement, the separation surface is at least partially profiled and/or has a friction-increasing surface.

Here, the term “friction-increasing surface” refers to a surface that generates higher friction than a polished surface, for example. Since the separation of liquid out of the mixture flow by way of the tangential flow along the separation surface is based on friction and deceleration effects, an at least partially friction-increasing surface assists such effects. The coefficient of friction may be set for example by way of an increased roughness. Alternatively or in addition, corresponding coatings may be provided on, or may form, the separation surface. Alternatively or in addition, the separation surface may also be at least partially profiled. The profiling, in the form of a surface structuring, can equally contribute to increasing the friction. Alternatively or in addition, a profiling, for example in the form of small depressions, can collect and further decelerate part of the mixture flow in the depressions for the purposes of separating off the liquid from the mixture flow. As a further alternative or in addition, the profiling may guide the mixture flow on a predetermined mixture flow path in order to avoid or at least reduce turbulence and/or limit the mixture flow to a certain region or targetedly guide the mixture flow. For example, the cylindrical body as described above may have a groove which leads from the second end side to the open first end side and which runs in spiral fashion around the longitudinal axis and in which the mixture flow is guided substantially tangentially. The spacing between the opposite groove walls, that is to say the groove width, may in this case progressively increase in continuous fashion or in successive portions in the direction of the open first end side, in order to generate additional deceleration or slowing effects by expansion of the mixture flow.

A further aspect of the disclosed embodiments relates to a coarse separator for a liquid separation device as described above, wherein the separation surface is designed as described with regard to the liquid separation device, such that a mixture flow can be introduced tangentially and in particular decelerated by way of an expansion of the flow cross section, diversion of the flow direction and/or friction along the separation surface.

As described above with regard to the various possible refinements of the separation surface, the coarse separator is configured such that it can decelerate a tangentially introduced mixture flow by friction, in particular in conjunction with a predetermined distance to be covered by the flow along the separation surface. A deceleration can also be further assisted by corresponding surface characteristics of the separation surface and an expansion of the flow cross section according to the ratio of the flow cross section of the mixture flow as it enters the coarse separator to its flow cross section as it exits the coarse separator and/or according to a diversion of the flow direction. In this way, not only can relatively large droplets be formed for the purposes of separation, but secondary spray can also be reduced. The aforementioned refinements of the coarse separator that have been described with regard to the liquid separation device, and the advantages respectively associated therewith, are accordingly also transferable directly to the coarse separator.

In a further aspect, the presently disclosed embodiments relate to a liquid separation system having a liquid separation device as described above and/or having a coarse separator as described above, wherein the liquid separation device is arranged in the liquid separation system such that the mixture flow exits the coarse separator at least with a vertical flow component, in particular with a flow component oriented in a direction of action of gravitational force, and/or the liquid separation system has a further liquid separator which is arranged such that the mixture flow can be fed to the further liquid separator at least partially in a flow direction oriented counter to gravitational force.

The mixture flow exiting the coarse separator may thus initially be oriented in the direction of the liquid sump before the mixture flow is fed, counter to gravitational force, in the direction of the further liquid separator. Here, the separation surface of the coarse separator is in particular at least partially open to the liquid sump in the direction of gravitational force, such that liquid that is separated off from the mixture flow at the separation surface can be collected in the liquid sump in the direction of gravitational force. Optionally, the separation surface is fully open toward the liquid sump in the direction of gravitational force, such that no liquid collects in a region of the separation surface. The mixture feed may in this case be arranged so as to pass through the liquid sump, and the mixture feed outlet is arranged above a predetermined maximum liquid sump level as viewed in the direction of gravitational force.

In the above alternative or additional variant, the further liquid separator is positioned downstream of the coarse separator in a flow direction of the mixture flow. The mixture feed is accordingly arranged such that the air-liquid mixture firstly impinges on the coarse separator and the mixture flow can then, after having flowed tangentially along the separation surface, be fed to the further liquid separator counter to gravitational force. The coarse separator and the further liquid separator may be arranged in a common housing or in a housing chamber formed by the housing. The mixture flow can then, after exiting the coarse separator, rise upward in the housing, counter to gravitational force, to the further liquid separator that is situated there. In an alternative, the further liquid separator may however also, as viewed in the direction of gravitational force, be situated at the same height as or below the point at which the mixture flow exits the coarse separator. In this case, the liquid separation system has a mixture flow guide which causes the mixture flow to flow at least in part counter to gravitational force in order to be fed to the further liquid separator. The mixture flow guide may be a partition, wherein the coarse separator is arranged on one side of the partition and the further liquid separator is arranged on another side of the partition. The partition has an aperture for the passage of the mixture flow, the aperture being arranged above the exit for the mixture flow as viewed in the direction of gravitational force. The further liquid separator may however also be arranged in a housing chamber that is separate from that of the coarse separator, wherein the mixture flow is fed to the further liquid separator via a mixture flow channel. The mixture flow channel has a mixture flow channel inlet that the mixture flow can enter proceeding from the coarse separator, wherein the mixture flow channel inlet is arranged, as viewed in the direction of gravitational force, above the point at which the mixture flow exits the coarse separator. Alternatively or in addition, the mixture flow channel may also have at least one portion in which the mixture flow is guided counter to gravitational force.

Owing to the fact that the mixture flow exits the coarse separator with at least a vertical flow component, in particular a flow component oriented in the direction of action of gravitational force, and/or the mixture flow is fed to the further liquid separator at least in part in a flow direction counter to gravitational force, liquid separation by gravitational force is assisted.

In one refinement, the liquid separation system has a liquid sump, and the further liquid separator, in particular a fine separator, is arranged on a side that is situated opposite the liquid sump as viewed in the direction of gravitational force.

In other words, the further liquid separator is arranged above the liquid sump as viewed in the direction of gravitational force. The mixture flow which, in this arrangement, rises upward to the further liquid separator counter to gravitational force can thus continue to separate off liquid into the liquid sump.

In one refinement, the liquid separation system has a housing that forms the separation surface of the coarse separator.

The housing of the liquid separation system can accordingly be designed such that an additional element for forming the coarse separator can be omitted. For example, a housing section may be concavely curved, in a direction parallel to the liquid level in the liquid sump, from the mixture feed outlet to the further liquid separator. In such a case, if the mixture flow is caused to flow from the mixture feed outlet, parallel to the liquid level and tangentially along the concavely curved housing section, to the further liquid separator, then liquid can be separated off from the mixture flow over this distance. Here, it may be advantageous if the separation surface formed by the housing portion is inclined in the direction of the liquid sump. It is however also possible for any of the other described separation surfaces to be replicated by the housing or the housing portion.

In particular, the mixture feed is oriented such that the mixture flow is directed counter to gravitational force.

For example, in the above configuration of the liquid separation system having a liquid sump and the further liquid separator that is situated opposite the liquid sump counter to the direction of gravitational force, the housing wall that extends from the liquid sump to the further liquid separator may be cylindrical. The mixture feed may be arranged in a region facing toward the liquid sump such that the air-liquid mixture impinges, in an upward inclination as viewed in the direction of gravitational force and at a small impingement angle, on the housing wall as a separation surface, and the mixture flow is guided tangentially along the cylindrical housing wall to the further liquid separator. In other words, the mixture flow is guided over the cylindrical housing wall in spiral fashion, counter to gravitational force, to the further liquid separator.

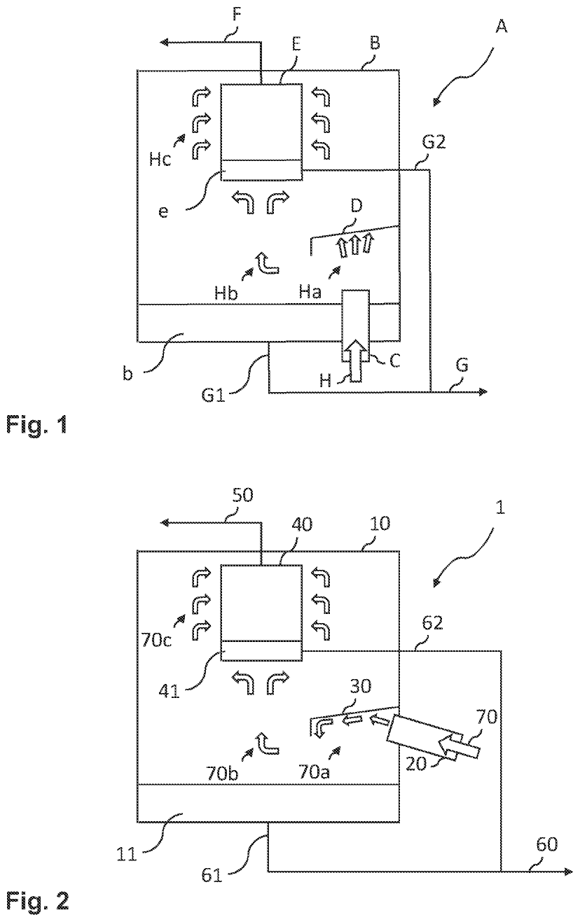

FIG. 1 is a schematic cross-sectional illustration of an oil separation system A as an example of a liquid separation system according to an example from the prior art. The oil separation system A has a housing B, the lower part of which as viewed in the direction of gravitational force forms an oil sump b. On an opposite side of the oil sump b as viewed in the direction of gravitational force, a fine separator is arranged in the housing B in an upper housing part as viewed in the direction of gravitational force. The fine separator E has, in a region facing toward the oil sump b, a fine separator oil sump e for collecting oil that is separated off in the fine separator E. The remaining air or at least an air-oil mixture with a reduced oil component is then discharged from the fine separator E via the air discharge line F. Oil from the oil sump b can be discharged from the housing A via an oil sump discharge line G1, and oil from the fine separator oil sump e can be discharged from the housing A via a fine separator oil sump discharge line G2. The oil sump discharge line G1 and the fine separator oil sump discharge line G2 are merged to form a common oil discharge line G.

Furthermore, a baffle plate D as a coarse separator is arranged in the housing A in order to reduce, by separation, the quantity of oil contained in the air-oil mixture H before the air-oil mixture H is fed to the fine separator E. The baffle plate D is spaced apart from a level surface in the oil sump b and has a separation surface facing toward the oil sump b. The air-oil mixture H is introduced into the housing A via a pressure nozzle C as a mixture feed. The pressure nozzle C is oriented such that a mixture flow Ha that impinges on the baffle plate D for the purposes of coarse separation impinges on the separation surface of the baffle plate D in a range of 90°+/−30°. For this purpose, the pressure nozzle C is led through the oil sump b, and the outlet opening of the pressure nozzle C is oriented substantially parallel to the baffle plate D or the separation surface thereof. In accordance with the angle and the speed at which the mixture flow Ha impinges on the baffle plate D, oil droplets of different size, but in particular also numerous relatively small oil droplets, are formed. The relatively large oil droplets fall under the action of gravitational force into the oil sump b, whereas relatively small droplets are distributed as secondary spray in the pressure chamber and can be transported onward, together with a mixture flow Hb in the housing A downstream of the baffle plate D, in the direction of the fine separator E counter to gravitational force. A mixture flow Hc that is fed to the fine separator E may thus, in particular owing to the secondary spray, still contain a sufficient oil component that influences the service life of the fine filter E and the efficiency of the compressor system.

For the purposes of reducing secondary spray, FIG. 2 shows a schematic cross-sectional illustration of an oil separation system 1 as an example of a liquid separation system according to an exemplary refinement, having an oil separation device as an example of a liquid separation device according to a first exemplary embodiment. The embodiment of the oil separation system 1 differs from the oil separation system A according to the prior art by the fact that the oil separation device is formed from the pressure nozzle 20, as a mixture feed, and the coarse separator 30 in an arrangement in which an air-oil mixture 70 impinges at a relatively small impingement angle on the separation surface of the coarse separator 30. Owing to the relatively small impingement angle, in particular in a range from 0° to 30°, in this case approximately 20°, a mixture flow 70a does not rebound from the separation surface but is guided tangentially along the separation surface. Owing to friction and deceleration effects, oil is separated off from the mixture flow 70a and can drip into an oil sump 11 that is situated opposite the separation surface. Secondary spray is substantially minimized. In the exemplary embodiment, the pressure nozzle 20 is not led through the oil sump 11 but is arranged on a side wall, which proceeds from the oil sump 11, of a housing 10 of the separation device.

The oil separation system 1 is otherwise similar to the oil separation system A. As already described above with regard to the prior art, the oil separation system 1 comprises the housing 10 that forms the oil sump 11. The housing 10 furthermore has a fine separator 40 which is arranged opposite the oil sump 11 and which has a fine separator oil sump 41. The oil from the oil sump 11 is discharged via an oil sump discharge line 61, and the oil from the fine separator oil sump 41 is discharged via a fine separator oil sump discharge line 62, the oil sump discharge line and fine separator oil sump discharge line being merged to form an oil discharge line 60. After the mixture flow 70a has passed tangentially along the separation surface, the mixture flow disperses further, as mixture flow 70b, in the pressure chamber formed by the housing 10, and is fed counter to gravitational force, as mixture flow 70c, to the fine separator 40. The air or at least an air-oil mixture with an oil component reduced by the fine separator 40 is then discharged from the fine separator 40 via the air discharge line 50.

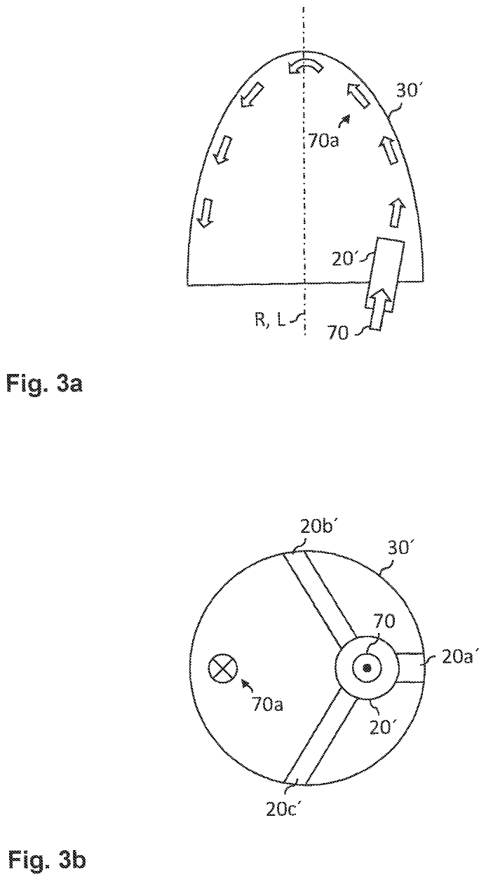

FIG. 3a is a schematic cross-sectional illustration of an oil separation device in a plane parallel to and through a longitudinal axis L of a coarse separator 30′ according to a second exemplary embodiment. The oil separation device has a pressure nozzle 20′ and the coarse separator 30′. The coarse separator 30′ is designed as a parabolic, rotationally symmetrical hollow body about the longitudinal axis L or axis of symmetry R, the hollow body extending along the axis of symmetry R from an opening formed by the greatest diameter to a by the reversal point of the parabolic profile. In other words, the coarse separator 30′ forms a dome-shaped body, with the reversal point of the parabolic profile corresponding to a dome tip. The inner surface of the coarse separator 30′ thus forms a concavely curved separation surface. The pressure nozzle 20′ projects with a mixture feed outlet through the opening of the coarse separator 30′ into the volume, formed by the separation surface, of the coarse separator 30′. In alternative embodiments, the pressure nozzle 20′ or the mixture feed outlet may however also be arranged outside the volume, formed by the separation surface, of the coarse separator 30′. The mixture feed outlet of the pressure nozzle 20′ is directed onto a parabolic side surface of the coarse separator 30′ such that the air-oil mixture 70 impinges on the separation surface with a relatively small impingement angle between the separation surface and the impingement direction of the air-oil mixture 70 as viewed in an impingement direction, the angle in this case being approximately 20°. The mixture flow runs tangentially along the separation surface in the direction of the axis of symmetry R or longitudinal axis L of the coarse separator 30′ toward the dome tip or of the reversal point of the parabolic profile, and is then, on the opposite separation surface, diverted back toward the opening in order to then emerge from the coarse separator 30′ again and be conducted onward as mixture flow 70b.

With regard to the oil separation system 1 shown in FIG. 2, the oil separation device according to FIG. 3a may be used, alternatively or in addition to the pressure nozzle 20 and the coarse separator 30, such that the opening of the coarse separator 30′ points in the direction of the oil sump 11. Oil that is separated off at the separation surface can thus, as far as possible, always drip into the oil sump 11. The pressure nozzle 20′ in this case points substantially in the direction of the oil sump 11, such that the pressure nozzle 20′ can also be led through same.

The pressure nozzle 20′ may be part of a housing block of an oil-lubricated screw compressor (not shown), which housing block discharges the compressed air-oil mixture 70 from the screw compressor. The coarse separator 30′ is in this case likewise already part of the housing block or correspondingly positionally fixedly connected, or in alternative embodiments positionally fixedly connectable, to the pressure nozzle 20′.

In addition to FIG. 3a, FIG. 3b is a schematic cross-sectional illustration of the oil separation device in a plane perpendicular to the longitudinal axis L or axis of symmetry R, according to the second exemplary embodiment. In other words, FIG. 3b shows a cross-sectional view according to a plan view of the oil separation device from FIG. 3a. The viewing direction is from the side of the dome tip, that is to say in the direction of the opening of the coarse separator 30′. The introduction of the air-oil mixture 70 into the coarse separator 30′ is represented by the circled dot, which corresponds to a flow direction out of the plane of the drawing. Here, the air-oil mixture is directed onto the separation surface. The mixture flow 70a that flows in the direction of the opening again on the other side of the separation surface is correspondingly represented by a circled cross, which corresponds to a flow direction into the plane of the drawing.

The pressure nozzle 20′ is in this case held with a positionally fixed connection to the coarse separator 30′ by three connecting struts 20a′, 20b′ and 20c′ as connecting mechanisms. In alternative embodiments, the pressure nozzle 20′ may also be connected to the coarse separator 30′ by more or fewer than three connecting struts or other connecting mechanisms. In the embodiment shown, the pressure nozzle 20′, the connecting struts 20a-c′ and the coarse separator 30′ are formed integrally with one another as one casting. Welded structures or other integral designs may alternatively be used. In further alternative embodiments, the respective connecting struts 20a-c′ may also each be screwed or releasably connected in some other way to the coarse separator 30′ and pressure nozzle 20′ in order to be able to set or adjust the relative position between pressure nozzle 20′ and coarse separator 30′ and/or be able to exchange individual components.

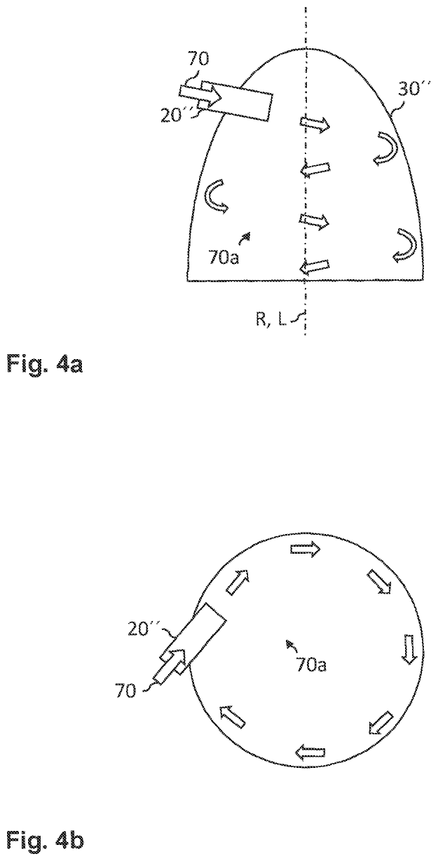

FIG. 4a is a schematic cross-sectional illustration of an oil separation device in a plane parallel to and through a longitudinal axis of a coarse separator 30″ according to a third exemplary embodiment. The third embodiment of the oil separation device differs from the second embodiment of the oil separation device by the arrangement of a pressure nozzle 20″ relative to the separation surface formed by the coarse separator 30″. As in the second embodiment of the oil separation device, the coarse separator 30″ is designed as a parabolic, rotationally symmetrical hollow body about the longitudinal axis L or axis of symmetry R, the hollow body extending along the axis of symmetry from an opening formed by the greatest diameter to a by the reversal point of the parabolic profile. In other words, it is also the case here that the coarse separator 30″ forms a dome-shaped body, with the reversal point of the parabolic profile corresponding to a dome tip. The inner surface of the coarse separator 30″ thus forms a concavely curved separation surface. The pressure nozzle 20″ is arranged in a region of the coarse separator 30″ that faces toward the dome tip, and the mixture feed outlet is inclined in the direction of the opening of the coarse separator 30″. The mixture feed outlet is furthermore oriented in the direction of the separation surface in order to direct the air-oil mixture onto the separation surface at an impingement angle of approximately 20° in the circumferential direction about the diameter of the coarse separator 30″. The mixture flow 70a is consequently guided tangentially in the circumferential direction and in spiral fashion in the direction of the opening of the coarse separator 30″.

In addition to this, FIG. 4b is a schematic cross-sectional illustration of the oil separation device in a plane perpendicular to the longitudinal axis L or axis of symmetry R, according to the third exemplary embodiment. The view shows once again the circular paths followed by the mixture flow 70a, which wind in spiral fashion in the direction of the opening of the coarse separator 30″.

With regard to the oil separation system 1 shown in FIG. 2, the oil separation device according to FIG. 4a and FIG. 4b may be used, alternatively or in addition to the pressure nozzle 20 and the coarse separator 30, such that the opening of the coarse separator 30″ points in the direction of the oil sump 11. Oil that is separated off at the separation surface can thus, as far as possible, always drip into the oil sump 11. With regard to the second embodiment shown in FIG. 3a and FIG. 3b, it is furthermore possible for the second embodiment to be converted into the third embodiment, or operated in accordance with the third embodiment, by way of a different arrangement of the pressure nozzle 20′ or the additional provision of the pressure nozzle 20″. In a variant in which the pressure nozzle 20′ can be correspondingly repositioned, the pressure nozzle 20′ is then not integrally connected to the coarse separator 30′ but can nevertheless be positionally fixedly connected to the coarse separator 30′. Similarly, the oil separation device according to the third embodiment can also be converted into an oil separation device of the second embodiment, or operated correspondingly. If two pressure nozzles 20′ and 20″ are provided in respective arrangements, it is for example possible for the air-oil mixture 70 to be introduced via the pressure nozzle 20′ and/or the pressure nozzle 20″. Simultaneous introduction via both pressure nozzles 20′ and 20″ may be dependent inter alia on a flow speed and the likelihood of turbulence and the effects thereof.

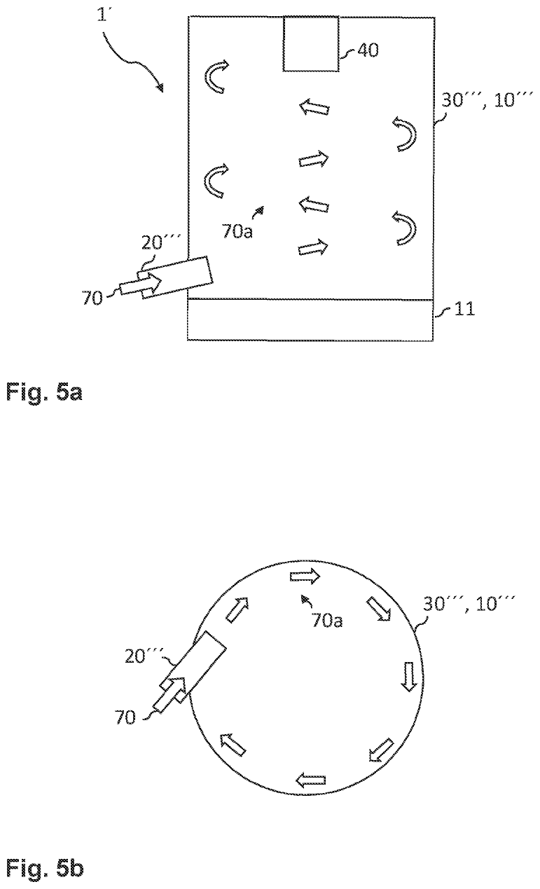

FIG. 5a is a schematic cross-sectional illustration of an oil separation system 1′ according to an exemplary variant, having an oil separation device according to a fourth exemplary embodiment. The oil separation system 1′ differs from the oil separation system 1 substantially in that a coarse separator 30′″ is not arranged within a housing 10′″ of the oil separation system 1′ but is formed by the housing 10′″ itself. For this purpose, the housing 10′″ has at least one housing portion as a separation surface. In the embodiment illustrated, the separation surface is formed by the lateral inner surfaces of the housing 10′″, which extend counter to gravitational force proceeding from the oil sump 11. Here, the pressure nozzle 20′″ is arranged laterally, above the oil sump 11 as viewed in the direction of gravitational force. The mixture feed outlet is inclined toward a side facing away from the oil sump 11. In this configuration, the mixture flow 70a is guided tangentially in spiral fashion, in the circumferential direction of the lateral inner surfaces of the housing 10′″ and counter to gravitational force, to the fine separator 40, which is arranged in an upper housing region as viewed in the direction of gravitational force, the upper housing region being situated opposite the oil sump 11.

FIG. 5b is a schematic cross-sectional illustration of the oil separation system 1′in a plane parallel to the oil sump 11 according to the fourth exemplary embodiment. In other words, FIG. 5b shows a plan view of the oil separation system 1′ as per FIG. 5a in a viewing direction toward the oil sump 11. Here, the section plane lies between the oil sump 11 and the fine separator 40. In the fourth embodiment, the lateral inner surfaces of the housing 10′″ form a cylinder. The cylindrical surfaces form the separation surface of the coarse separator 30′″ thus formed. As described above, the mixture feed outlet is inclined slightly in the direction of the fine separator 40, such that the mixture flow 70a is likewise oriented with a flow component in the direction of the fine separator. In other words, each of the arrows representing the mixture flow 70a, starting from the first arrow downstream of the pressure nozzle 20′″, is situated closer, as viewed clockwise and in the direction of gravitational force, that is to say in a vertical direction during intended use, to the fine separator 40 than the respectively proceeding arrow.

Disclosed embodiments are not restricted to the embodiments described. Even though an oil separation device, a coarse separator and an oil separation system for separating off oil have been described in the embodiments described above, the liquid separation device, a corresponding coarse separator and a liquid separation system according to the present invention are not restricted to the use of oil or of a liquid that contains oil. It is for example also possible for other liquids, which are alternatively or additionally used in the compressor system for the purposes of cooling and/or lubrication, to be separated off. It is also possible for the separation device to have multiple mixture feeds, and/or for the mixture feed to have multiple mixture feed outlets, in order to direct several mixture flows selectively or simultaneously onto the separation surface.

### LIST OF REFERENCE DESIGNATIONS

1, 1′ Oil separation system (liquid separation system)
10 Housing
11 Oil sump (liquid sump)
20, 20′, 20″, 20′″ Pressure nozzle (mixture feed)
20a′, 20b′, 20c′ Connecting strut (connecting mechanisms)
30, 30′, 30″, 30′″ Coarse separator
40 Fine separator (further liquid separator)
41 Fine separator oil sump (fine separator liquid sump)
50 Air discharge line
60 Oil discharge line (liquid discharge line)
61 Oil sump discharge line (liquid sump discharge line)
62 Fine separator oil sump discharge line (fine separator liquid sump discharge line)
70 Air-oil mixture (air-liquid mixture)
70a Mixture flow (coarse separator)
70b Mixture flow (housing)
70c Mixture flow (fine separator)
A Oil separation system (liquid separation system)
B Housing
b Oil sump (liquid sump)
C pressure nozzle (mixture feed)
D Baffle plate (coarse separator)
E Fine separator
e Fine separator oil sump (fine separator liquid sump)
F Air discharge line
G Oil discharge line (liquid discharge line)
G1 Oil sump discharge line (liquid sump discharge line)
G2 Fine separator oil sump discharge line (fine separator liquid sump discharge line)
H Air-oil mixture (air-liquid mixture)
Ha Mixture flow (coarse separator)
Hb Mixture flow (housing)
Hc Mixture flow (fine separator)
L Longitudinal axis
R Axis of symmetry

1. A liquid separation device for a compressor system, the liquid separation device comprising:
a coarse separator with at least one separation surface, and
at least one mixture feed configured to feed an air-liquid mixture to the at least one separation surface,
wherein the at least one mixture feed has a mixture feed outlet which faces toward the at least one separation surface and is arranged relative to the separation surface of the coarse separator such that a mixture flow that impinges on the separation surface is guided substantially tangentially over at least a portion of the separation surface.

2. The liquid separation device of claim 1, wherein a cross section of the mixture feed outlet facing toward the separation surface is smaller than or equal to half to one third of, an exit area over which the mixture flow exits the coarse separator.

3. The liquid separation device of claim 1, wherein the mixture feed is positionally fixedly connected or connectable to the coarse separator.

4. The liquid separation device of claim 3, wherein the connection of the mixture feed to the coarse separator includes a plurality of deformable connecting struts.

5. The liquid separation device of claim 3, wherein the relative position of the mixture feed and the coarse separator is adjustable using an adjustment device.

6. The liquid separation device of claim 3, wherein the connection of the mixture feed to the coarse separator is releasable.

7. The liquid separation device of claim 3, wherein the mixture feed and the coarse separator are formed integrally.

8. The liquid separation device of claim 1, wherein the separation surface, facing toward the mixture feed, of the coarse separator is substantially concavely curved at least in a cross-sectional portion through which the mixture flow is intended to pass, and the mixture feed is arranged such that the mixture flow is at least partially guided substantially along the concave curvature.

9. The liquid separation device of claim 8, wherein the separation surface of the coarse separator is parabolic or dome-shaped wherein a dome which conically narrows toward a dome tip, and wherein the mixture feed is arranged such that the mixture flow is guided at least from one side of the separation surface to the other side of the separation surface via a parabolic direction reversal or a dome arch.

10. The liquid separation device of claim 8, wherein the separation surface of the coarse separator forms a parabolic, cylindrical or conical body with at least an open first end side with and a closed second end side of the cylinder or a closed end portion, situated opposite the open first end side, of the parabolic or conical body, and wherein the mixture feed is arranged such that the mixture flow is guided in a circumferential direction of the parabolic, cylindrical or conical body tangentially along the parabolic, cylindrical or conical separation surface in the direction of the open first end side.

11. The liquid separation device of claim 8, wherein the separation surface is curved such that the mixture flow can, proceeding from its flow direction when exiting the mixture feed to the point at which it exits the coarse separator, be diverted through at least 90°.

12. The liquid separation device of claim 1, wherein the separation surface is at least partially profiled and/or has a friction-increasing surface.

13. A coarse separator for a liquid separation device as claimed in claim 1, wherein a cross section of the mixture feed outlet facing toward the separation surface is smaller than or equal to half to one third of an exit area over which the mixture flow exits the coarse separator, such that a mixture flow is introduced tangentially and decelerated by way of an expansion of the flow cross section, diversion of the flow direction and/or friction along the separation surface.

14. A liquid separation system having a liquid separation device of claim 1, and/or a coarse separator, wherein the cross section of the mixture feed outlet facing toward the separation surface is smaller than or equal to half to one third of an exit area over which the mixture flow exits the coarse separator, such that a mixture flow can be introduced tangentially and decelerated by way of an expansion of the flow cross section, diversion of the flow direction and/or friction along the separation surface, wherein the liquid separation device is arranged in the liquid separation system such that the mixture flow exits the coarse separator at least with a vertical flow component, with a flow component oriented in a direction of action of gravitational force, and/or the liquid separation system has a further liquid separator which is arranged such that the mixture flow can be fed to the further liquid separator at least partially in a flow direction oriented counter to gravitational force.

15. The liquid separation system of claim 14, wherein the liquid separation system includes a liquid sump, and the further liquid separator is a fine separator and is arranged on a side that is situated opposite the liquid sump as viewed in the direction of gravitational force.

16. The liquid separation system of claim 14, wherein the liquid separation system has a housing that forms the separation surface of the coarse separator.

17. The liquid separation system of claim 16, wherein the mixture feed is oriented such that the mixture flow is directed counter to gravitational force.
